(19) United States
(12) Patent Application Publication
(10) Pub. No.: US 2024/0060790 A1
(43) Pub. Date: Feb. 22, 2024

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventors: Takashige HORI, Aisai-shi (JP); Kouji NISHIYAMA, Toyota-shi (JP)

(73) Assignee: TOYOTA JIDOSHA KABUSHIKI KAISHA, Toyota-shi (JP)

(21) Appl. No.: 18/330,718

(22) Filed: Jun. 7, 2023

(30) Foreign Application Priority Data
Aug. 18, 2022 (JP) 2022-130542

(51) Int. Cl. G01C 21/34

(52) U.S. Cl. CPC G01C 21/3492; G01C 21/3423

(57) ABSTRACT

The control unit of the information processing device acquires first information including information on a destination of the user, a departure point at which the user starts to move to the destination, a scheduled arrival time to the destination, and a first scheduled time at which the user starts to move from the departure point to the destination. The control unit of the information processing device acquires the second information on the traffic situation predicted at a specific time at a specific time, which is a time retroactive to a predetermined time from the first scheduled time, and determines the second scheduled time at which a user should start moving from the departure to the destination in order to arrive at the destination by the scheduled time of arrival based on the first information and the second information.

### CROSS-REFERENCE TO RELATED APPLICATION

This application claims priority to Japanese Patent Application No. 2022-130542 filed on Aug. 18, 2022, incorporated herein by reference in its entirety.

### BACKGROUND

### 1. Technical Field

The present disclosure relates to an information processing device, an information processing method, and a program.

### 2. Description of Related Art

Japanese Unexamined Patent Application Publication No. 2020-148466 (JP 2020-148466 A) discloses an information processing device. The information processing device disclosed in JP 2020-148466 A estimates a staying point of a user in each time zone based on a location information history of a terminal used by the user. The information processing device specifies a departure point of the user by comparing the estimated staying point of the user for each time zone with a start time set in a schedule in which the destination and the start time are set. The information processing device searches for a moving route and a required time for moving from the specified departure point to the destination set in the schedule. The information processing device calculates a departure time for moving to the destination from the searched required time. Then, the information processing device registers the movement schedule including the departure time in schedule information of the user.

### SUMMARY

An object of the present disclosure is to provide a technique that enables a user to start moving to a destination at an optimum time.

A first aspect of the present disclosure is an information processing device. A control unit of the information processing device executes:
acquiring first information including information about a destination of a user, a departure point from which movement to the destination is started, a scheduled arrival time to the destination, and a first scheduled time at which movement from the departure point to the destination is started; and
acquiring second information about a traffic condition predicted in a specific time that is a time tracked back from the first scheduled time by a predetermined time, and determining a second scheduled time at which the user is to start moving from the departure point to the destination so as to arrive at the destination by the scheduled arrival time based on the first information and the second information.

In the first aspect, the control unit may further execute:
acquiring third information about a traffic condition predicted in a predetermined timing repeated at a predetermined interval from the specific time, repeatedly in the predetermined timing; and
determining the second scheduled time based on the first information and the third information, repeatedly in the predetermined timing.

In the first aspect, the control unit may further execute notifying the user when the second scheduled time that has been determined does not coincide with the first scheduled time.

In the first aspect, the control unit may acquire a moving distance from the departure point to the destination based on the first information, and may determine the predetermined time based on the moving distance.

In the first aspect, the first information may include a moving method when the user moves from the departure point to the destination, and the control unit may determine the predetermined time based on the moving method.

In the first aspect, the first information may include fourth information about a traffic condition on a route from the departure point to the destination at the first scheduled time, the traffic condition being predicted when the first scheduled time is determined, and the control unit may determine the predetermined time based on the fourth information.

In the first aspect, the control unit may further execute determining the predetermined interval based on the first information.

In the first aspect, the control unit may acquire a moving distance from the departure point to the destination based on the first information, and may determine the predetermined interval based on the moving distance.

In the first aspect, the first information may include a moving method when the user moves from the departure point to the destination, and the control unit may determine the predetermined interval based on the moving method.

In the first aspect, the first information may include fourth information about a traffic condition on a route from the departure point to the destination at the first scheduled time, the traffic condition being predicted when the first scheduled time is determined, and the control unit may determine the predetermined interval based on the fourth information.

In the first aspect, the control unit may shorten the predetermined interval as a time elapses from the specific time.

A second aspect of the present disclosure is an information processing method executed by a computer.

The information processing method includes:
acquiring first information including information about a destination of a user, a departure point from which movement to the destination is started, a scheduled arrival time to the destination, and a first scheduled time at which movement from the departure point to the destination is started; and
acquiring second information about a traffic condition predicted in a specific time that is a time tracked back from the first scheduled time by a predetermined time, and determining a second scheduled time at which the user is to start moving from the departure point to the destination so as to arrive at the destination by the scheduled arrival time based on the first information and the second information.

In the second aspect, the information processing method may further include:
acquiring third information about a traffic condition predicted in a predetermined timing repeated at a predetermined interval from the specific time, repeatedly in the predetermined timing; and determining the second scheduled time based on the first information and the third information, repeatedly in the predetermined timing.

In the second aspect, the information processing method may further include notifying the user when the second scheduled time that has been determined does not coincide with the first scheduled time.

In the second aspect, the information processing method may further include determining the predetermined interval based on the first information.

In the second aspect, the information processing method may shorten the predetermined interval as a time elapses from the specific time.

A third aspect of the present disclosure is a program for causing a computer to execute an information processing method. The information processing method includes: acquiring first information including information about a destination of a user, a departure point from which movement to the destination is started, a scheduled arrival time to the destination, and a first scheduled time at which movement from the departure point to the destination is started; and
acquiring second information about a traffic condition predicted in a specific time that is a time tracked back from the first scheduled time by a predetermined time, and determining a second scheduled time at which the user is to start moving from the departure point to the destination so as to arrive at the destination by the scheduled arrival time based on the first information and the second information.

In the third aspect, the information processing method may further include: acquiring third information about a traffic condition predicted in a predetermined timing repeated at a predetermined interval from the specific time, repeatedly in the predetermined timing; and
determining the second scheduled time based on the first information and the third information, repeatedly in the predetermined timing.

In the third aspect, the information processing method may further include notifying the user when the second scheduled time that has been determined does not coincide with the first scheduled time.

In the third aspect, the information processing method may further include determining the predetermined interval based on the first information.

According to the present disclosure, it is possible for the user to start moving to the destination at an optimum time.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a schematic configuration of a management system according to the present embodiment;

FIG. 2 is a diagram illustrating an example of a time series of information processing performed by the management server;

FIG. 3 is a block diagram schematically illustrating an example of a functional configuration of a management server;

FIG. 4 is an example of a table configuration of traffic information held in a traffic information database;

FIG. 5 is a diagram illustrating an example of a table configuration of user information held in a user information database;

FIG. 6 is a flowchart of the first information processing;

FIG. 7 is a diagram illustrating a correspondence between a moving distance and a predetermined time when the control unit determines a predetermined time;

FIG. 8 is a flowchart of the second information processing.

FIG. 9 is a diagram illustrating a correspondence between a moving distance and a predetermined interval when the control unit determines the predetermined interval;

FIG. 10 is a flowchart of the third information processing.

### DETAILED DESCRIPTION OF EMBODIMENTS

An information processing device according to a first aspect of the present disclosure is an information processing device that manages a schedule of a user. Here, it is assumed that, as a schedule of the user, a destination, a departure point at which the user starts moving to the destination, a scheduled arrival time to the destination, and a first scheduled time at which the user starts moving from the departure point to the destination are scheduled.

In this case, it is assumed that the first scheduled time is not an appropriate time as the time at which the user starts moving from the departure point to the destination due to a change in the traffic situation. As an example in which the first scheduled time is not an appropriate time as a time at which the user starts moving from the departure point to the destination, it can be exemplified that even if the user starts moving to the destination at the first scheduled time due to a change in the traffic situation, the user cannot arrive at the destination by the scheduled arrival time. Further, as an example in which the first scheduled time is not an appropriate time as a time at which the user starts moving from the departure point to the destination, even if the user starts moving to the destination at the first scheduled time, the user arrives at the destination at a time earlier than the scheduled arrival time by a certain time or more.

Therefore, the control unit of the information processing device acquires the first information including information on the destination, the departure point at which the user starts to move to the destination, the scheduled arrival time to the destination, and the first scheduled time. Then, the control unit of the information processing device acquires the second information at the specific time, and determines the second scheduled time based on the first information and the second information. Here, the specific time is a time which is traced back from the first scheduled time by a predetermined time. The second information is information about a traffic situation predicted at a specific time. Further, the predetermined time is determined such that the specific time is a time after the time at which the first scheduled time is determined. The second scheduled time is a time at which the user should start moving from the departure point to the destination in order to arrive at the destination by the scheduled arrival time. That is, the control unit determines again the scheduled time at which the movement from the departure point to the destination should be started at a time later than the time at which the first scheduled time is determined.

As described above, the information processing device determines the second scheduled time again based on the traffic situation predicted at the specific time that is the time after the time at which the first scheduled time is determined. Therefore, it is possible to suppress the user from starting the movement to the destination at the first scheduled time at which the time at which the user is scheduled to start the movement to the destination is not an appropriate time due to the change in the traffic situation. As a result, the user can start moving to the destination at the optimum time.

Hereinafter, specific embodiments of the present disclosure will be described with reference to the drawings. Unless otherwise specified, dimensions, materials, shapes, relative arrangements, and the like of components described in the present embodiments are not intended to limit the technical scope of the present disclosure to those alone.

### First Embodiment

### System Overview

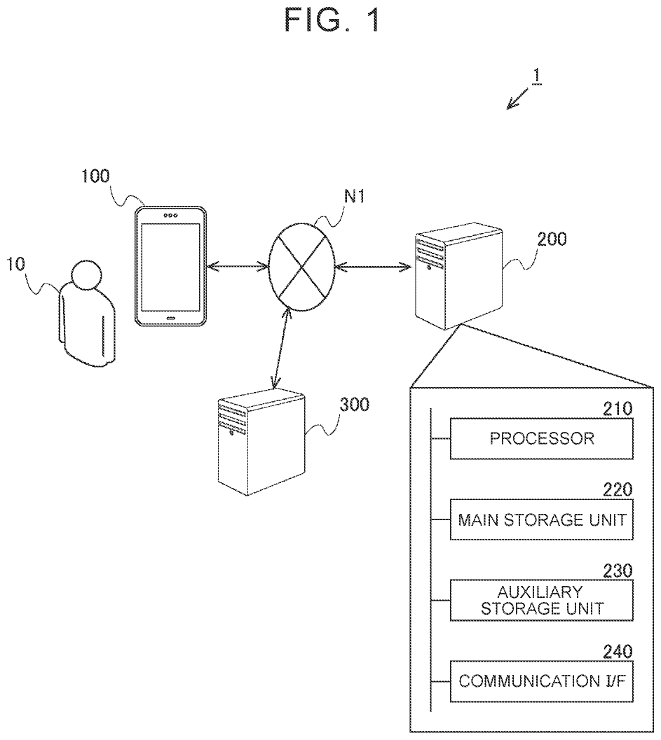

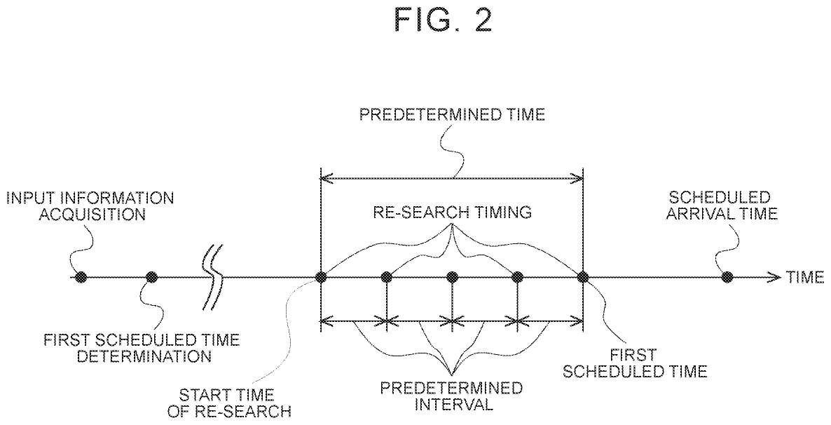

The management system 1 according to the present embodiment will be described with reference to FIGS. 1 to 2. FIG. 1 is a diagram illustrating a schematic configuration of a management system 1 according to the present embodiment. The management system 1 includes a user terminal 100, a management server 200, and a traffic server 300. In the management system 1, a user terminal 100, a management server 200, and a traffic server 300 are connected to each other via a network N1. The network N1 may employ, for example, a Wide Area Network (WAN) which is a global public communication network such as the Internet, or a telephone communication network such as a cellular telephone.

### User Terminal

The user terminal 100 is a terminal related to the user 10. The user terminal 100 is, for example, a computer or a personal digital assistant used by the user 10. The user 10 uses the user terminal 100 to input a schedule of the user 10 to the user terminal 100. Here, the user 10 uses the user terminal 100 to input a destination (hereinafter, may be simply referred to as a “destination”) to which the user 10 is scheduled to move. In addition, the user 10 uses the user terminal 100 to input a departure point (hereinafter, sometimes simply referred to as “departure point”) at which the user starts to move to the destination. Further, the user 10 uses the user terminal 100 to input a scheduled arrival time to the destination (hereinafter, may be simply referred to as “scheduled arrival time”). Further, the user 10 uses the user terminal 100 to input a method of moving from a departure point to a destination (hereinafter, may be simply referred to as a “moving method”). In the present embodiment, the user 10 inputs to the user terminal 100 that the vehicle is to be used as a moving method.

The user terminal 100 transmits information including a destination, a departure point, a scheduled arrival time, and a moving method (hereinafter, may be referred to as “input information”) to the management server 200. Then, the user terminal 100 receives the information including the first scheduled time determined by the management server 200 based on the input information. Here, the first scheduled time is a time at which the user 10 is scheduled to start moving from the departure point to the destination. In this way, the user terminal 100 acquires the first scheduled time. Thus, the user 10 can grasp the first scheduled time, which is the time at which the user starts moving from the departure point to the destination and can arrive at the destination by the scheduled arrival time.

### Traffic Server

The traffic server 300 is a server device that predicts a traffic volume on a road. The traffic server 300 calculates a predicted value of the traffic amount in each road section at each date and time based on a time transition of the traffic amount in each road section, and the like. The traffic server 300 transmits the predicted value of the traffic amount in each road section at each date and time to the management server 200. A known method can be adopted as a method in which the traffic server 300 calculates a predicted value of the traffic amount in each road section at each date and time based on a time transition of the traffic amount in each road section.

### Management Server

The management server 200 is a server device that manages the schedule of the user 10. The management server 200 receives the input information from the user terminal 100 via the network N1. The management server 200 determines the first scheduled time based on the destination, the departure point, and the scheduled arrival time in the input information. The management server 200 transmits the information including the first scheduled time to the user terminal 100 via the network N1. Details of the method by which the management server 200 determines the first scheduled time will be described later.

In this case, it is assumed that the first scheduled time is not an appropriate time as the time at which the user 10 starts moving from the departure point to the destination due to the change in the traffic situation. As an example in which the first scheduled time is not an appropriate time as the time at which the user 10 starts moving from the departure point to the destination, it can be exemplified that even if the user starts moving to the destination at the first scheduled time due to a change in the traffic situation, the user cannot arrive at the destination by the scheduled arrival time. Further, as an example in which the first scheduled time is not an appropriate time as a time at which the user 10 starts moving from the departure point to the destination, even if the user starts moving to the destination at the first scheduled time, the user arrives at the destination at a time earlier than the scheduled arrival time by a certain time or more. The reason for the change in the traffic situation may be, for example, a traffic trouble such as occurrence of a traffic jam or a road blockage caused by construction work or the like.

In addition, the management server 200 acquires information on a predicted value of the traffic amount predicted at the re-search start time at a time before a predetermined time (hereinafter, sometimes referred to as “re-search start time”) of the first scheduled time. Then, the management server 200 determines the second scheduled time based on the input information and the information on the predicted value of the traffic amount predicted at the re-search start time. Here, the second scheduled time is a time at which the user 10 should start moving from the departure point to the destination in order for the user 10 to arrive at the destination by the scheduled time. Further, the predetermined time is determined such that the re-search start time is a time after the time at which the first scheduled time is determined. Further, in the present embodiment, the predetermined time is a predetermined time. A method for the management server 200 to determine the second scheduled time will be described later.

In addition, the management server 200 repeatedly acquires information on a predicted value of the traffic amount predicted at the re-search timing set a plurality of times. Here, the re-search timing is a timing including a timing corresponding to the re-search start time and a plurality of timings repeated at predetermined intervals from the re-search start time. The management server 200 repeatedly determines the second scheduled time based on the input information and the information on the predicted value of the traffic amount predicted at the corresponding timing at the plurality of re-search timings. Accordingly, the second scheduled time can be obtained based on the predicted value of the latest traffic amount predicted at the re-search timing even after the re-search start time. In the present embodiment, the predetermined interval is a predetermined interval.

FIG. 2 is a diagram illustrating an example of a time series of information processing performed by the management server 200. As illustrated in FIG. 2, the management server 200 first acquires input information from the user terminal 100. The management server 200 determines the first scheduled time based on the acquired input information.

The management server 200 performs a re-search of a route for arriving from the departure point to the expected arrival time at the destination at a time (re-search start time) that is a predetermined time before the first scheduled time. Further, as illustrated in FIG. 2, the management server 200 repeatedly arrives at the re-search timing at a predetermined interval from the re-search start time. The management server 200 performs a route re-search every time a re-search timing arrives. In the example illustrated in FIG. 2, the management server 200 performs the re-search of the route five times between the re-search start time and the first scheduled time.

The management server 200 is configured to include a computer including a processor 210, a main storage unit 220, an auxiliary storage unit 230, and a communication interface (communication I/F) 240. The processor 210 is, for example, Central Processing Unit (CPU) or Digital Signal Processor (DSP). The main storage unit 220 is, for example, a Random Access Memory (RAM). The auxiliary storage unit 230 is, for example, a Read Only Memory (ROM). The auxiliary storage unit 230 is, for example, a Hard Disk Drive (HDD), a CD-ROM, DVD disc, or a disc recording medium such as a Blu-ray disc. The auxiliary storage unit 230 may be a removable medium (a portable storage medium). Examples of the removable medium include a USB memory or an SD card. The communication I/F 240 is, for example, a Local Area Network (LAN) interface board or wireless communication circuitry for wireless communication.

In the management server 200, an operating system (OS), various programs, various information tables, and the like are stored in the auxiliary storage unit 230. In the management server 200, when the processor 210 loads the program, which is stored in the auxiliary storage unit 230, to the main storage unit 220 for execution, various functions, which will be described, can be realized. However, some or all of the functions of the management servers 200 may be realized by hardware circuitry such as ASIC or FPGA. Moreover, the management server 200 does not have to be implemented by a single physical configuration, and may be configured by a plurality of computers that cooperate with each other. Similarly to the management server 200, the traffic server 300 includes a computer.

### Functional Configuration

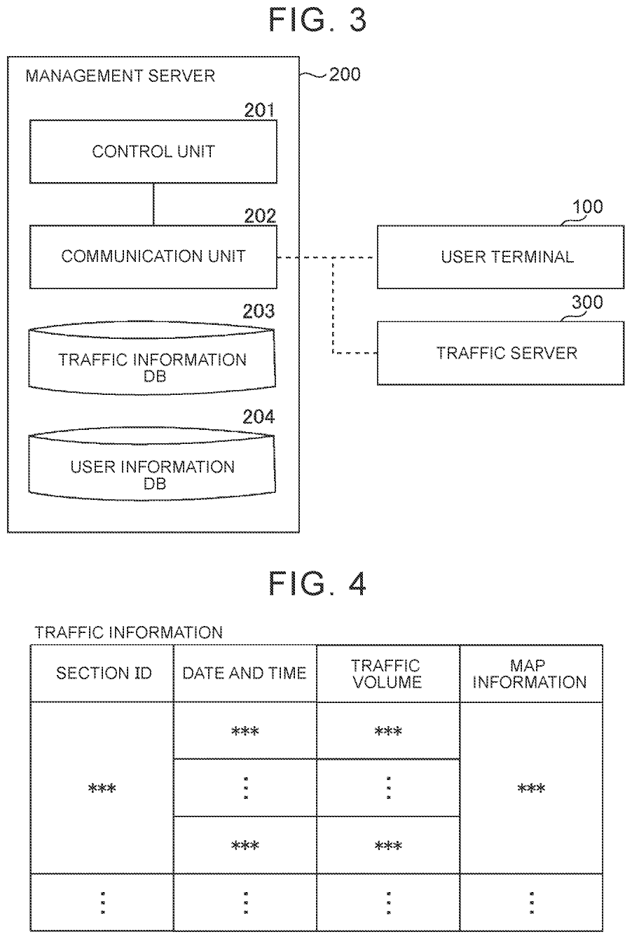

Next, the functional configuration of the management server 200 constituting the management system 1 according to the present embodiment will be described with reference to FIG. 3 to FIG. 5. FIG. 3 is a block diagram schematically illustrating an example of a functional configuration of the management server 200. The management server 200 includes a control unit 201, a communication unit 202, a traffic information database 203 (traffic information DB 203), and a user information database 204 (user information DB 204).

The control unit 201 has a function of performing arithmetic processing for controlling the management server 200. The control unit 201 can be realized by the processor 210 in the management server 200. The communication unit 202 has a function of connecting the management servers 200 to a network N1. The communication unit 202 can be realized by a communication I/F 240 in the management servers 200.

The traffic information DB 203 has a function of holding traffic information. The traffic information is information about a predicted value of the traffic amount of the road section at each date and time. The traffic information DB 203 can be realized by the auxiliary storage unit 230 in the management server 200. The control unit 201 receives, by the communication unit 202, a predicted value of the traffic amount in each road section at each date and time from the traffic server 300. The control unit 201 stores, in the traffic information DB 203, predicted traffic volumes in the respective road sections at the respective dates and times received from the traffic servers 300.

FIG. 4 is an exemplary table configuration of traffic information held in the traffic information DB 203. As illustrated in FIG. 4, the traffic information includes a section ID field, a date and time field, a traffic volume field, and a map information field. In the section ID field, an identifier (section ID) for specifying a road section is inputted. In the date and time field, information for specifying the date and time is input. In the traffic volume field, a predicted traffic volume of a road segment corresponding to the section ID entered in the corresponding section ID field at the date and time entered in the corresponding date and time field is inputted.

The control unit 201 repeatedly receives the predicted value of the traffic amount from the traffic server 300 at a predetermined cycle. Then, the control unit 201 updates the traffic information based on the predicted value of the received traffic amount. Accordingly, the control unit 201 can constantly acquire a predicted value of the latest traffic volume from the traffic information DB 203.

The control unit 201 receives input information from the user terminal 100 by the communication unit 202. The control unit 201 generates user information based on the input information received from the user terminal 100. The control unit 201 stores the generated user information in the user information DB 204. The user information DB 204 has a function of holding user information. The user information is information related to the movement of the user 10 scheduled at the first scheduled time. The user information DB 204 can be realized by the auxiliary storage unit 230 in the management server 200.

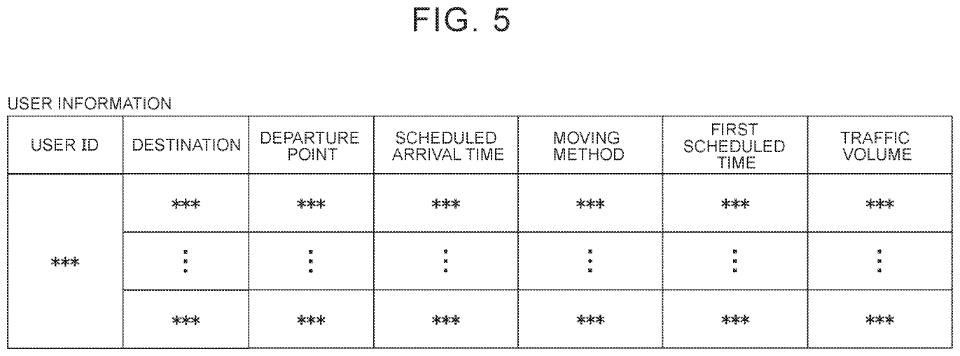

FIG. 5 is a diagram illustrating an exemplary table configuration of user information held in the user information DB 204. As illustrated in FIG. 5, the user information includes a user ID field, a destination field, a starting point field, an arrival time field, a traveling method field, a first scheduled time field, and a traffic volume field.

In the user ID field, an identifier (user ID) for identifying the user 10 is inputted. In the destination field, information on the destination of the user 10 is input. The destination information is, for example, an address or coordinates (latitude and longitude) of the destination. In the departure point field, information of the departure point of the user 10 is input. The information of the departure point is, for example, an address or a coordinate (latitude and longitude) of the departure point. The scheduled arrival time to the destination entered in the corresponding destination field is entered in the arrival fixed time field. In the movement method field, information on the movement method to the destination input in the corresponding destination field is input. In the present embodiment, since the user 10 moves to a destination using an automobile, information indicating that the moving method is an automobile is input to the moving method field. The control unit 201 inputs various types of information to the destination field, the departure point field, the expected arrival time field, and the movement method field based on the input information received from the user terminal 100.

In the first scheduled time field, a first scheduled time at which the user 10 starts moving to the destination is input. The control unit 201 determines the first scheduled time based on various kinds of information inputted in the destination field, the departure point field, the scheduled arrival time field, and the travel mode field, and the traffic information held in the traffic information DB 203. Here, the traffic information acquired by the control unit 201 from the traffic information DB 203 indicates a traffic condition (a predicted traffic volume) predicted at the time when the first scheduled time is determined. The control unit 201 determines the first scheduled time by searching for a route to arrive from the departure point to the scheduled arrival time on the basis of the traffic situation predicted at the time of determining the first scheduled time.

In the traffic amount field, information on a predicted value of the traffic amount in each road section in the route searched when the first scheduled time is determined is input. When determining the first scheduled time, the control unit 201 inputs information on a predicted value of the traffic amount of the respective road sections on the route from the departure point to the destination in the traffic information acquired from the traffic information DB 203 into the traffic amount field.

Note that a known method can be adopted as a method in which the management server 200 determines a route for arriving from the departure point to the scheduled arrival time at the destination and a time at which the departure point should be departed for arriving at the scheduled arrival time at the destination.

The control unit 201 acquires the user information held in the user information DB 204. Thus, the control unit 201 can grasp the destination, the departure point, the scheduled arrival time, and the first scheduled time. The control unit 201 acquires the traffic information from the traffic information DB 203 every time a re-search timing (a timing corresponding to the re-search start time and a plurality of times repeated at predetermined intervals from the re-search start time) arrives from a predetermined time prior to the first scheduled time. Thus, the control unit 201 can grasp the predicted value of the latest traffic amount predicted at the re-search timing.

Based on the user information and the traffic information acquired at the re-search timing, the control unit 201 re-searches for a route to arrive from the departure point to the expected arrival time at the destination, and determines the second scheduled time. Here, it is assumed that a traffic situation predicted when the first scheduled time is determined and a traffic situation predicted when the second scheduled time is determined change. In other words, the prediction of the traffic situation in the past may be different from the prediction of the latest traffic situation. As a result, the first scheduled time and the second scheduled time may be different times. In this case, in the prediction of the traffic situation in the past and the prediction of the latest traffic situation, the accuracy is higher in the prediction of the latest traffic situation. Therefore, the accuracy of the second scheduled time is higher between the first scheduled time and the second scheduled time.

Therefore, when the second scheduled time different from the first scheduled time is calculated, the control unit 201 transmits, by the communication unit 202, notification information indicating that the time at which the user 10 should depart from the departure point to the destination is from the first scheduled time to the second scheduled time to the user terminal 100. Thus, the user terminal 100 that has received the notification information can notify the user 10 that the time at which the departure from the departure point to the destination is from the first scheduled time to the second scheduled time. As a result, the user 10 can recognize that it is better to depart at the second scheduled time instead of the first scheduled time. When the first scheduled time coincides with the second scheduled time, the control unit 201 may not transmit the notification information.

### First Information Processing

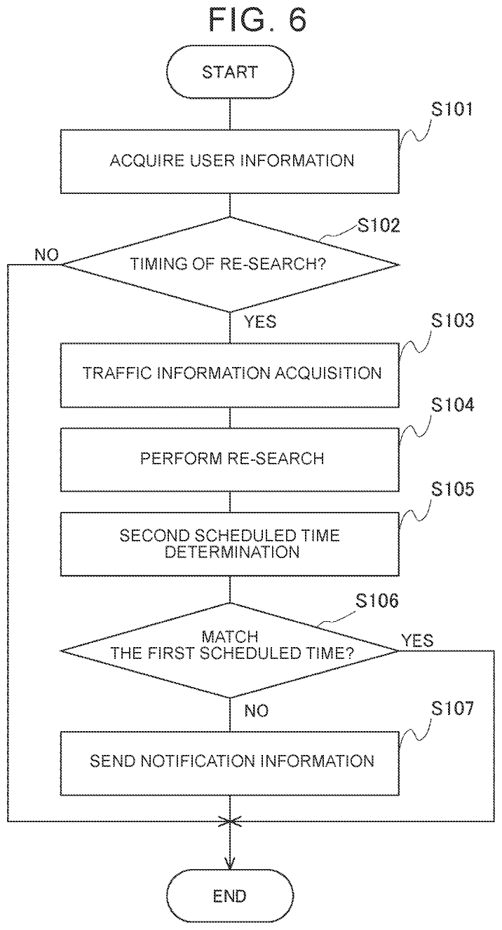

Next, the first information processing executed by the control unit 201 of the management server 200 in the management system 1 will be described with reference to FIG. 6. The first information processing is processing for determining the second scheduled time. FIG. 6 is a flowchart of the first information processing. The first information processing is repeatedly executed at a predetermined cycle from the time when the management server 200 receives the input information from the user terminal 100.

In the first information processing, first, in S101, user information is acquired from the user information DB 204. Next, in S102, it is determined whether or not the present time is the re-search timing based on the user information. When a negative determination is made in S102, the present time is not the re-search timing, and thus the second scheduled time does not need to be determined. Therefore, the first information processing is ended.

If an affirmative determination is made in S102, the traffic information is obtained from the traffic information DB 203 in S103. Thus, the control unit 201 can acquire the predicted value of the latest traffic amount predicted at the re-search timing. Next, in S104, based on the user information acquired in S101 and the traffic information acquired in S103, a re-search of a route that arrives from the departure point to the expected arrival time at the destination is performed. Next, in S105, a second scheduled time is determined based on the outcome of the re-search.

Next, in S106, it is determined whether or not the first scheduled time coincides with the second scheduled time. If a negative determination is made in S106, the user 10 needs to know that the user should begin moving toward the destination at the second scheduled time. Therefore, the notification is transmitted to the user terminal 100 in S107. When an affirmative determination is made in S106, the user 10 may depart toward the destination at the first scheduled time. Therefore, the notification information is not transmitted. Then, the first information processing is ended.

Here, the execution of the first information processing is repeated until the time at which the user 10 should depart (the earlier time of the first scheduled time or the second scheduled time). Thus, the second scheduled time is determined until the user 10 departs.

As described above, in the present embodiment, the information processing device determines the second scheduled time based on the traffic situation predicted by the re-search start time, which is a time after the time at which the first scheduled time is determined. Therefore, it is possible to suppress the user 10 from starting to move to the destination at the first scheduled time when the time when the user 10 is scheduled to start to move to the destination is not an appropriate time due to the change in the traffic situation. In the present embodiment, the second scheduled time is also determined at the re-search timing after the re-search start time. Accordingly, the second scheduled time can be determined based on the latest traffic situation predicted after the re-search start time. Accordingly, the user 10 can start moving to the destination at the second scheduled time determined based on the latest traffic situation. In this way, the user can start moving to the destination at the optimum time.

### Modification 1 of the First Embodiment

In the present embodiment, the user 10 inputs to the user terminal 100 that the vehicle is to be used as a method of moving from the departure point to the destination. However, the user 10 does not necessarily have to input to the user terminal 100 that the vehicle is to be used as a method of moving from the departure point to the destination. For example, the user 10 may input that a railway is to be used as a method of moving from the departure point to the destination. In this case, the management server 200 receives the predicted value of the delay of the railway from the server device that manages the delay status of the railway instead of the traffic server 300. Then, the management server 200 determines the first scheduled time and the second scheduled time based on the predicted value of the delay of the railway.

Further, the user 10 may input to the user terminal 100 as a moving method that the user moves on foot in addition to the automobile and the railway. In this case, it is assumed that the walkway or the like changes the walking speed according to the situation of congestion. Therefore, the management server 200 acquires the congestion state of the sidewalk or the like from the server device that manages the congestion state of the sidewalk or the like instead of the traffic server 300. Then, the management server 200 determines the first scheduled time and the second time based on the congestion state such as the sidewalk.

In addition, the user 10 may input to the user terminal 100 that an airplane is used as a moving method. In this case, it is assumed that the time required for the movement changes due to a delay or the like of the airplane. Therefore, the management server 200 acquires the delay status of the airplane from the server device that manages the delay of the airplane. Then, the management server 200 determines the first scheduled time and the second scheduled time based on the delay state of the airplane.

### Modification 2 of the First Embodiment

In the present embodiment, the management server 200 performs the route re-search at the re-search timing that repeatedly arrives at a predetermined interval even after the re-search start time until the first scheduled time. However, the management server 200 does not necessarily need to perform the route re-search at the re-search timing that arrives after the re-search start time. That is, the management server 200 does not necessarily have to determine the second scheduled time at the re-search timing that arrives after the re-search start time. Even in this manner, since the re-search of the route is executed at the re-search start time, the second scheduled time can be determined based on the traffic information predicted at a time later than the time when the first scheduled time is determined. Even in this manner, the user can start moving to the destination at the optimum time.

### Second Embodiment

In the present embodiment, the management server 200 determines a predetermined time, that is, a timing at which the re-search is started, based on the user information. That is, the management server 200 determines the re-search start time based on the user information. Hereinafter, only differences from the first embodiment will be described.

When the user 10 travels over a long distance, there is a higher possibility of being involved in a traffic trouble such as a traffic jam as compared with a case where the user travels over a short distance. In this case, when the user 10 moves over a long distance, there is a higher possibility that the moving time changes as compared with a case where the user moves over a short distance. Therefore, in a case where the user 10 moves over a long distance, it is preferable to set the re-search start time earlier to secure a time period in which the user 10 can respond to a change in the movement time. In addition, it is preferable to notify the user 10 of the change of the time at which the movement to the destination should be started earlier by increasing the re-search start time. On the other hand, in both the case of traveling over a long distance and the case of traveling over a short distance, when the re-search start time is uniformly increased regardless of the traveling distance in consideration of the traffic trouble, there is a disadvantage that the load when the management server 200 performs the re-search of the route becomes large. Therefore, in the second embodiment, the management server 200 determines the re-search start time based on the travel distance from the departure point to the destination of the user 10.

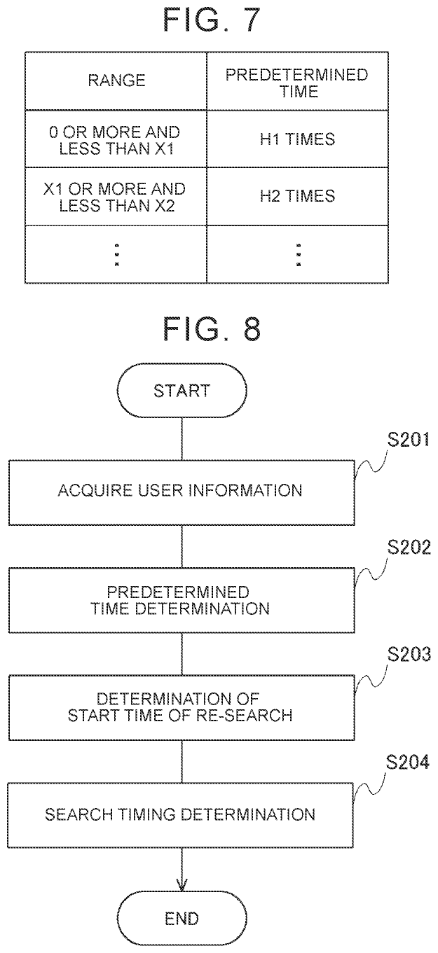

The control unit 201 calculates the travel distance from the departure point to the destination based on the user information held in the user information DB 204. Then, the control unit 201 determines a predetermined time based on the travel distance from the departure point to the destination. FIG. 7 is a diagram illustrating a correspondence between a moving distance and a predetermined time when the control unit 201 determines a predetermined time. As illustrated in FIG. 7, when the travel distance from the departure point to the destination is included in the range of 0 or more and less than X1, the predetermined time is determined as H1 time. That is, in this case, the search starting time is determined to be H1 time prior to the first scheduled time. In addition, when the travel distance from the departure point to the destination is included in the range of X1 or more and less than X2, the predetermined time is determined as H2 time. That is, in this case, the search starting time is determined to be H2 time prior to the first scheduled time.

Here, H2 time is a longer time between H1 time and H2 time. That is, H1 times and H2 times are set so that the time when the travel distance from the departure point to the destination is included in the range of X1 or more and less than X2 is earlier than the time when the travel distance from the departure point to the destination is included in the range of 0 or more and less than X1.

When the moving distance is equal to or greater than X2 value, the predetermined period is determined according to the range in which the moving distance is included. That is, even when the moving distance is equal to or larger than X2, the search starting time is determined based on a predetermined time determined in accordance with the range in which the moving distance is included. Here, when the ranges of the two moving distances are compared, a predetermined time is set such that a predetermined time in which the minimum value of the range of the moving distance is larger is a time in which the minimum value of the range of the moving distance is longer than a predetermined time in which the minimum value of the range of the moving distance is smaller. That is, the predetermined time is set such that the re-search start time when the moving distance included in the range of the moving distance is moved is earlier than the re-search start time when the moving distance included in the range of the moving distance is moved is smaller. In this way, the correspondence between the moving distance and the predetermined time is set so that the moving distance and the predetermined time have a positive correlation.

### Second Information Processing

Next, the second information processing executed by the control unit 201 of the management server 200 in the management system 1 will be described with reference to FIG. 8. The second information processing is processing for determining a re-search timing. FIG. 8 is a flowchart of the second information processing. The second information processing is executed when the management server 200 receives the input information from the user terminal 100 and generates the user information.

In the second information processing, first, user information is acquired in S201. Next, in S202, a predetermined period is determined according to the travel distance calculated based on the user information. Next, in S203, a predetermined time prior to the first scheduled time is determined as the re-search starting time. Next, in S204, a timing corresponding to the re-search start time and a plurality of times of timings repeated at predetermined intervals from the re-search start time are determined as the re-search timing. In the present embodiment, the predetermined interval is a predetermined interval. Then, the second information processing is ended.

As described above, in the second embodiment, in the management system 1, the re-search start time is determined by determining a predetermined time according to the moving distance of the user 10. Accordingly, it is possible to determine the re-search disclosure time according to the possibility of being involved in a traffic trouble caused by the travel distance of the user 10. As a result, even when the user 10 moves over a long distance, the user 10 can start moving to the destination at the optimum time while suppressing the load on the management server 200.

### Modification 1 of the Second Embodiment

In the present embodiment, the management server 200 determines a predetermined time based on the moving distance. However, the management server 200 does not necessarily have to determine a predetermined time based on the moving distance. When the user 10 moves, for example, it is assumed that the travel time is more likely to fluctuate due to the reason that the vehicle is caught in a traffic jam or the like as compared with the railway. Therefore, it is preferable to increase the re-search start time in accordance with the movement method of the user 10 to secure a time period in which the user 10 can respond to a change in the movement time. In addition, it is preferable to notify the user 10 of the change of the time at which the movement to the destination should be started earlier by increasing the re-search start time.

On the other hand, in a case where the re-search start time is uniformly increased regardless of the moving method in consideration of the traffic trouble, there is a disadvantage that the load when the management server 200 performs the re-search of the route becomes large. Therefore, the management server 200 may determine the re-search start time by determining a predetermined time based on the moving method from the departure point to the destination of the user 10. Even in this manner, the user 10 can start moving to the destination at the optimum time while suppressing the load on the management server 200.

### Modification 2 of the Second Embodiment

In the present modification, the management server 200 determines the predetermined time based on the information on the traffic situation on the route from the departure point to the destination at the first scheduled time, which is predicted when the first scheduled time is determined. Here, when it is predicted that a traffic jam occurs on a route from the departure point to the destination at the first scheduled time when the first scheduled time is determined, it is predicted that the travel time tends to fluctuate. Therefore, in a case where it is predicted that a traffic jam occurs on a route from the departure point to the destination at the first scheduled time when the first scheduled time is determined, it is preferable to set the re-search start time earlier to secure a time period in which the user 10 can cope with a change in the travel time. In addition, it is preferable to notify the user 10 of the change of the time at which the movement to the destination should be started earlier by increasing the re-search start time. On the other hand, in a case where the re-search start time is uniformly increased regardless of the traffic situation predicted when the first scheduled time is determined in consideration of the traffic trouble, there is a disadvantage that the load when the management server 200 performs the re-search of the route increases.

Therefore, the management server 200 may acquire, from the user information held in the user information DB 204, information on a predicted value (hereinafter, sometimes referred to as a “first predicted value”) of the traffic volume of the route from the departure point to the destination at the first scheduled time, which is predicted when the first scheduled time is determined. For example, the management server 200 determines a predetermined time based on the range of the predicted value of the traffic amount to which the first predicted value belongs. In this case, in a case where the first predicted value is included in the range in which the minimum value of the range of the predicted value of the traffic amount is larger, the predetermined time is set so that the re-search start time is earlier than in a case where the first predicted value is included in the range in which the minimum value of the range of the predicted value of the traffic amount is smaller. Even in this manner, it is possible to cause the user 10 to start moving to the destination at the optimum time while suppressing the load on the management server 200.

### Third Embodiment

In the present embodiment, the management server 200 determines a predetermined interval, that is, an interval at which the route is searched again, based on the user information. Hereinafter, only differences from the first embodiment will be described.

When the user 10 travels over a long distance, there is a higher possibility of being involved in a traffic trouble such as a traffic jam as compared with a case where the user travels over a short distance. In this case, when the user 10 moves over a long distance, there is a higher possibility that the moving time changes as compared with a case where the user moves over a short distance. Therefore, when the user 10 travels over a long distance, it is preferable to acquire more than the latest traffic situation prediction and always notify the user 10 of the second scheduled time based on the latest traffic situation prediction. That is, when the user 10 moves over a long distance, the predetermined interval is preferably shorter than when the user 10 moves over a short distance. On the other hand, in both cases of long-distance travel and short-distance travel, when the predetermined interval is uniformly shortened regardless of the travel distance in consideration of the traffic trouble, there is a disadvantage that the load when the management server 200 performs the re-search of the route increases. Therefore, in the third embodiment, the management server 200 determines a predetermined interval based on the travel distance from the departure point to the destination of the user 10.

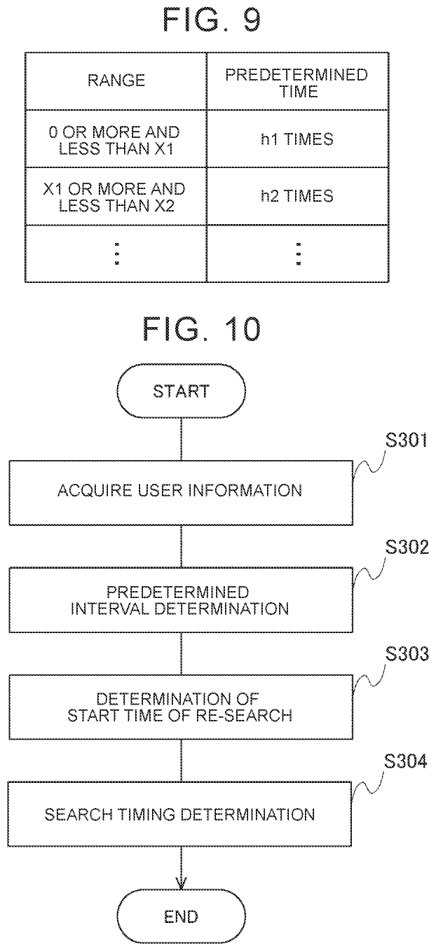

The control unit 201 acquires the travel distance from the departure point to the destination based on the user information held in the user information DB 204. The control unit 201 determines a predetermined interval based on the travel distance from the departure point to the destination. FIG. 9 is a diagram illustrating a correspondence between a moving distance and a predetermined interval when the control unit 201 determines the predetermined interval. As illustrated in FIG. 9, when the travel distance from the departure point to the destination is included in the range of 0 or more and less than X1, the predetermined interval is determined as h1 time. In addition, when the travel distance from the departure point to the destination is included in the range of X1 or more and less than X2, the predetermined interval is determined as h2 period.

Here, h2 time is a shorter time between h1 time and h2 time. That is, when the travel distance from the departure point to the destination is included in the range of X1 or more and less than X2, the predetermined interval is set so that the predetermined interval is shorter than when the travel distance from the departure point to the destination is included in the range of 0 or more and less than X1.

When the moving distance is equal to or greater than X2 value, the predetermined distance is determined according to the range including the moving distance. Here, when the ranges of the two moving distances are compared, a predetermined interval is set such that a predetermined interval in which the minimum value of the range of the moving distance is larger is a time shorter than a predetermined interval in which the minimum value of the range of the moving distance is smaller. In this way, the correspondence between the moving distance and the predetermined interval is set so that the moving distance and the predetermined time have a negative correlation.

### Third Information Processing

Next, the third information processing executed by the control unit 201 of the management server 200 in the management system 1 will be described with reference to FIG. 8. The second information processing is processing for determining a re-search timing. FIG. 10 is a flowchart of the third information processing. The third information processing is executed when the management server 200 receives the input information from the user terminal 100 and generates the user information.

In the third information processing, first, user information is acquired in S301. Next, in S302, a predetermined distance is determined according to the travel distance calculated based on the user information. Next, in S303, the re-search timing is determined so that the re-search timing becomes a predetermined interval from a predetermined time prior to the first scheduled time. In the present embodiment, the predetermined time is a predetermined interval. That is, the re-search start time is a predetermined time. Then, the third information processing is ended.

As described above, in the third embodiment, in the management system 1, the predetermined interval is determined in accordance with the moving distance of the user 10, and thus the predetermined interval is determined. Accordingly, it is possible to determine the interval of the re-search timing according to the possibility of being involved in a traffic trouble caused by the travel distance of the user 10. As a result, even in the case of moving over a long distance, it is possible to cause the user 10 to start moving to the destination at the optimum time while suppressing the load on the management server 200.

### Modification 1 of the Third Embodiment

In the present embodiment, the management server 200 determines a predetermined interval based on the moving distance. However, the management server 200 does not necessarily have to determine a predetermined interval based on the moving distance. For example, it is assumed that the moving time is likely to vary depending on the moving method of the user 10. Therefore, the predetermined interval may be shortened according to the moving method of the user 10. This makes it possible to always notify the second scheduled time to the user 10 based on the latest prediction of the traffic situation. On the other hand, in a case where the predetermined interval is uniformly shortened regardless of the moving method in consideration of the traffic trouble, there is a disadvantage that the load when the management server 200 performs the re-search increases. Therefore, the management server 200 may determine the re-search timing by determining a predetermined interval based on the moving method from the departure point to the destination of the user 10. Even in this manner, it is possible to cause the user 10 to start moving to the destination at the optimum time while suppressing the load on the management server 200.

### Modification 2 of the Third Embodiment

In the present modification, the management server 200 determines the predetermined interval based on the information on the traffic situation on the route from the departure point to the destination at the first scheduled time, which is predicted when the first scheduled time is determined. Here, when it is predicted that a traffic jam occurs on a route from the departure point to the destination at the first scheduled time when the first scheduled time is determined, it is predicted that the travel time tends to fluctuate. Therefore, in a case where it is predicted that a traffic jam occurs on a route from the departure point to the destination at the first scheduled time when the first scheduled time is determined, the predetermined interval may be shortened. Accordingly, the second scheduled time can be notified to the user 10 based on the latest prediction of the traffic situation. On the other hand, in a case where the predetermined interval is uniformly shortened regardless of the traffic situation in consideration of the traffic trouble, there is a possibility that the load when the management server 200 performs the re-search becomes large.

Therefore, the management server 200 may acquire the first predicted value from the user information stored in the user information DB 204. Then, the predetermined time may be determined based on the range of the predicted value of the traffic amount to which the first predicted value belongs. In this case, in a case where the first predicted value is included in the range in which the minimum value of the range of the predicted value of the traffic amount is larger, the predetermined interval is set so that the predetermined interval is shorter than in a case where the first predicted value is included in the range in which the minimum value of the range of the predicted value of the traffic amount is smaller. Even in this manner, it is possible to cause the user 10 to start moving to the destination at the optimum time while suppressing the load on the management server 200.

### Modification 3 of the Third Embodiment

In the present embodiment, the management server 200 determines a predetermined interval based on the user information. However, the management server 200 does not necessarily have to determine a predetermined interval based on the user information. Here, it is assumed that the closer the first scheduled time is, the more difficult it is for the user 10 to arrive at the destination by the scheduled arrival time when the travel time fluctuates. Therefore, as the first scheduled time becomes closer, the frequency of the re-search may be increased, and the second scheduled time may be notified to the user 10 based on the latest prediction of the traffic situation. However, if the predetermined interval is uniformly shortened in consideration of traffic troubles, the load on the management server 200 may increase. Therefore, the control unit 201 may shorten the predetermined interval as time elapses from the re-search start time. Accordingly, when there is a certain time from the first scheduled time, the control unit 201 can perform the re-search more frequently as the first scheduled time becomes closer while increasing the re-search interval. Even in this manner, it is possible to cause the user 10 to start moving to the destination at the optimum time while suppressing the load on the management server 200.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In a computer system, it is possible to flexibly change which hardware configuration (server configuration) realizes each function.

The functions described in the above embodiments may be realized by supplying an implemented computer program to a computer, and one or more processors included in the computer read and execute the program. Such a computer program may be provided to a computer by a non-transitory computer-readable storage medium capable of being connected to a system bus of the computer, or may be provided to the computer via a network. Examples of the non-transitory computer-readable storage medium include a disc of any type such as a magnetic disk (a floppy (registered trademark) disk, hard disk drive (HDD), and the like) or an optical disc (such as a CD-ROM, a DVD disc, and a Blu-ray disc), a ROM, a RAM, an EPROM, an EEPROM, a magnetic card, a flash memory, an optical card, and any type of medium suitable for storing electronic instructions.

What is claimed is:

1. An information processing device comprising a control unit configured to execute:
acquiring first information including information about a destination of a user, a departure point from which movement to the destination is started, a scheduled arrival time to the destination, and a first scheduled time at which movement from the departure point to the destination is started; and
acquiring second information about a traffic condition predicted in a specific time that is a time tracked back from the first scheduled time by a predetermined time, and determining a second scheduled time at which the user is to start moving from the departure point to the destination so as to arrive at the destination by the scheduled arrival time based on the first information and the second information.

2. The information processing device according to claim 1, wherein the control unit further executes:
acquiring third information about a traffic condition predicted in a predetermined timing repeated at a predetermined interval from the specific time, repeatedly in the predetermined timing; and
determining the second scheduled time based on the first information and the third information, repeatedly in the predetermined timing.

3. The information processing device according to claim 1, wherein the control unit further executes notifying the user when the second scheduled time that has been determined does not coincide with the first scheduled time.

4. The information processing device according to claim 1, wherein the control unit
acquires a moving distance from the departure point to the destination based on the first information, and
determines the predetermined time based on the moving distance.

5. The information processing device according to claim 1, wherein:
the first information includes a moving method when the user moves from the departure point to the destination; and
the control unit determines the predetermined time based on the moving method.

6. The information processing device according to claim 1, wherein:
the first information includes fourth information about a traffic condition on a route from the departure point to the destination at the first scheduled time, the traffic condition being predicted when the first scheduled time is determined; and
the control unit determines the predetermined time based on the fourth information.

7. The information processing device according to claim 2, wherein the control unit further executes determining the predetermined interval based on the first information.

8. The information processing device according to claim 7, wherein the control unit
acquires a moving distance from the departure point to the destination based on the first information, and
determines the predetermined interval based on the moving distance.

9. The information processing device according to claim 7, wherein:
the first information includes a moving method when the user moves from the departure point to the destination; and
the control unit determines the predetermined interval based on the moving method.

10. The information processing device according to claim 7, wherein:
the first information includes fourth information about a traffic condition on a route from the departure point to the destination at the first scheduled time, the traffic condition being predicted when the first scheduled time is determined; and
the control unit determines the predetermined interval based on the fourth information.

11. The information processing device according to claim 2, wherein the control unit shortens the predetermined interval as a time elapses from the specific time.

12. An information processing method executed by a computer, the information processing method comprising:
acquiring first information including information about a destination of a user, a departure point from which movement to the destination is started, a scheduled arrival time to the destination, and a first scheduled time at which movement from the departure point to the destination is started; and
acquiring second information about a traffic condition predicted in a specific time that is a time tracked back from the first scheduled time by a predetermined time, and determining a second scheduled time at which the user is to start moving from the departure point to the destination so as to arrive at the destination by the scheduled arrival time based on the first information and the second information.

13. The information processing method according to claim 12, further comprising:
acquiring third information about a traffic condition predicted in a predetermined timing repeated at a predetermined interval from the specific time, repeatedly in the predetermined timing; and
determining the second scheduled time based on the first information and the third information, repeatedly in the predetermined timing.

14. The information processing method according to claim 12, further comprising notifying the user when the second scheduled time that has been determined does not coincide with the first scheduled time.

15. The information processing method according to claim 13, further comprising determining the predetermined interval based on the first information.

16. The information processing method according to claim 13, wherein the predetermined interval is shortened as a time elapses from the specific time.

17. A program for causing a computer to execute an information processing method comprising:
acquiring first information including information about a destination of a user, a departure point from which movement to the destination is started, a scheduled arrival time to the destination, and a first scheduled time at which movement from the departure point to the destination is started; and
acquiring second information about a traffic condition predicted in a specific time that is a time tracked back from the first scheduled time by a predetermined time, and determining a second scheduled time at which the user is to start moving from the departure point to the destination so as to arrive at the destination by the scheduled arrival time based on the first information and the second information.

18. The program according to claim 17, wherein the information processing method further includes:
acquiring third information about a traffic condition predicted in a predetermined timing repeated at a predetermined interval from the specific time, repeatedly in the predetermined timing; and
determining the second scheduled time based on the first information and the third information, repeatedly in the predetermined timing.

19. The program according to claim 17, wherein the information processing method further includes notifying the user when the second scheduled time that has been determined does not coincide with the first scheduled time.

20. The program according to claim 18, wherein the information processing method further includes determining the predetermined interval based on the first information.
